(19) United States
(12) Patent Application Publication
(10) Pub. No.: US 2019/0391899 A1
(43) Pub. Date: Dec. 26, 2019

(54) COMPUTER PROGRAM STORED IN COMPUTER READABLE MEDIUM, DATABASE SERVER AND AUDIT PERFORMING SERVER

(71) Applicant: TmaxData Co., Ltd., Gyeonggi-do (KR)

(72) Inventors: Ji Mahn MOON, Gyeonggi-do (KR); Bon Cheol KOO, Gyeonggi-do (KR); Changho Hwang, Gyeonggi-do (KR); Sunkyun Jin, Seoul (KR); Sangyoung Park, Gyeonggi-do (KR)

(21) Appl. No.: 16/021,272

(22) Filed: Jun. 28, 2018

(30) Foreign Application Priority Data
Jun. 20, 2018 (KR) 10-2018-0070672

(51) Int. Cl. G06F 11/34; G06F 17/30

(52) U.S. Cl. CPC G06F 11/3476; G06F 11/3409; G06F 17/30979; G06F 17/30002

(57) ABSTRACT

A computer program stored in a computer readable storage medium according to an exemplary embodiment of the present disclosure includes: commands for making a computer perform operations, in which the operations include: receiving query performance details generated while performing a query from a database server; storing the received query performance details in a storage unit; generating an audit log based on the query performance details and audit setting information stored in the storage unit; and storing the audit log in an audit log storage unit.

### CROSS-REFERENCE TO RELATED APPLICATIONS

This application claims priority to and the benefit of Korean Patent Application No. 10-2018-0070672 filed in the Korean Intellectual Property Office on Jun. 20, 2018, the entire contents of which are incorporated herein by reference.

### TECHNICAL FIELD

The present disclosure relates to an audit function performing server, a database server, and a computer program, and particularly, to performance of an audit function by a database server and a separate audit function performing server.

### BACKGROUND ART

Enterprise business is rapidly expanded by an explosive increase in data and an appearance of various environments and platforms. According to the advent of a new business environment, there is a need for more efficient and flexible data service and information processing and data management function. According to the change, research on a database for solving high performance, high availability, and expandability issues, which are the bases of the implementation of the enterprise business, is continuously conducted.

A database management system (DBMS) may store a data file in each disk. Further, the DBMS may manage a disk space including disks. Accordingly, the DBMS may enhance integrity of data and improve accessibility to data. The DBMS representatively includes Tibero, Oracle, IMS, and the like.

In the meantime, the database server may perform an audit function of recording corresponding contents in a file or a database for a user unintended structured query language (SQL). However, the database server needs to progress a process, such as examining an SQL and recording an audit log, for performing the audit function, so that there is a problem in that performance of the database server is degraded.

Accordingly, a development of a database server, in which the problem in the related art is solved, is urgently needed.

### RELATED ART LITERATURE

### Patent Document

(Patent Document 0001) Korean Patent No. KR10-1619482

(Patent Document 0002) Korean Patent No. KR10-2009-0112016

### SUMMARY OF THE INVENTION

The present disclosure is conceived in response to the foregoing background technology, and provides an audit function performing device, which is capable of performing an audit function in a database system and maintaining performance of a database server, a database server, and a computer program stored in a computer readable medium.

The technical objects of the present disclosure are not limited to the foregoing technical objects, and other non-mentioned technical objects will be clearly understood by those skilled in the art from the description below.

According to several exemplary embodiments of the present disclosure for solving the foregoing problems, a computer program stored in a computer readable storage medium includes commands for making a computer perform operations, in which the operations include: receiving query performance details generated while performing a query from a database server; storing the received query performance details in a storage unit; generating an audit log based on the query performance details and audit setting information stored in the storage unit; and storing the audit log in an audit log storage unit.

According to other several exemplary embodiments of the present disclosures, a computer program stored in a computer readable storage medium includes commands for making a computer perform operations, in which the operations include: receiving a query from a user terminal; processing the query through a query processing module; storing query performance details in a storage module through a background system module in linkage with the processing of the received query; and controlling a communication module through the background system module so as to transmit the query performance details stored in the storage module to an audit performing server, in order to cause the audit performing server to generate an audit log by using the query performance details.

According to still other exemplary embodiments of the present disclosure, a server for performing an audit includes: a communication unit, which receives query performance details generated while performing a query from a database server; a storage unit, which stores the received query performance details; an audit log generating unit, which generates an audit log based on the query performance details and audit setting information stored in the storage unit; and an audit log storage unit, which stores the audit log.

According to yet other exemplary embodiments of the present disclosure, a database server includes: a query receiving module, which receives a query received from a user terminal; a query processing module, which processes the received query; and a background system module, which stores query performance details in a storage module in linkage with the processing of the received query by the query processing module, in which the background system module controls a communication module through the background system module so as to transmit the query performance details stored in the storage module to an audit performing server, in order to cause the audit performing server to generate an audit log by using the query performance details.

The technical solutions obtainable from the present disclosure are not limited to the foregoing solutions, and other non-mentioned solution means will be clearly understood by those skilled in the art from the description below.

According to several exemplary embodiments of the present disclosure, it is possible to solve a problem of degradation of performance of the database server while the database system performs an audit function.

The effects obtainable from the present disclosure are not limited to the foregoing effects, and other non-mentioned effects will be clearly understood by those skilled in the art from the description below.

### BRIEF DESCRIPTION OF THE DRAWINGS

Various aspects are described with reference to the drawings, and herein, like reference numerals are generally used to designate like constituent elements. In the exemplary embodiment below, for the purpose of description, a plurality of specific and detailed matters are suggested in order to provide general understanding of one or more aspects. However, it is apparent that the aspect(s) may be carried out without the specific and detailed matters.

FIG. 1 is a schematic diagram of a database management system according to several exemplary embodiments.

FIG. 2 is a diagram illustrating a block diagram illustrating a database server according to several exemplary embodiments of the present disclosure.

FIG. 3 is a diagram illustrating a block diagram illustrating an audit performing server according to several exemplary embodiments of the present disclosure.

FIG. 4 is a flowchart for describing an example of a method of performing an audit according to several exemplary embodiments of the present disclosure.

FIG. 5 is a flowchart for describing an example of a method of transmitting query performance details to the audit performing server according to several exemplary embodiments of the present disclosure.

FIG. 6 is a flowchart for describing an example of a method of generating an audit log according to several exemplary embodiments of the present disclosure.

FIG. 7 is a block diagram illustrating a computer according to an exemplary embodiment of the present disclosure.

### DETAILED DESCRIPTION

Advantages and characteristics, and a method for achieving them will be clear when exemplary embodiments described in detail with reference to the accompanying drawings are referred to. However, the present disclosure is not limited to exemplary embodiments disclosed herein but will be implemented in various forms, and the exemplary embodiments are provided so that the present disclosure is completely disclosed, and a person of ordinary skilled in the art can fully understand the scope of the present disclosure, and the present disclosure will be defined only by the scope of the appended claims. A size and a relative size of a constituent element illustrated in the drawing may be exaggerated for clearness of the description. Throughout the specification, the same reference numeral indicates the same constituent element, and an expression “and/or” includes each of the mentioned items and all of the combinations including one or more of the items.

Hereinafter, the same or similar constituent element is denoted by the same reference numeral regardless of a reference numeral, and a repeated description thereof will be omitted. Further, in describing the exemplary embodiment disclosed in the present disclosure, when it is determined that detailed description relating to well-known functions or configurations may make the subject matter of the exemplary embodiment disclosed in the present disclosure ambiguous, the detailed description will be omitted. Further, the accompanying drawings are provided for helping to easily understand exemplary embodiments disclosed in the present specification, and the technical spirit disclosed in the present specification is not limited by the accompanying drawings.

A term used in the present specification is for describing the exemplary embodiments, and does not intend to limit the present disclosure. In the present specification, a singular form includes a plural form as well, unless otherwise mentioned. A term “comprises” and/or “comprising” do not exclude the existence or an addition of one or more other constituent elements, in addition to the mentioned constituent element.

Although “a first”, “a second”, and the like are used for describing various elements or constituent elements, but the elements or the constituent elements are not limited by the terms. The terms are used for discriminating one element or constituent element from another element or constituent element. Accordingly, a first element or constituent element mentioned below may also be a second element or constituent element within the technical spirit of the present disclosure as a matter of course.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly defined.

Suffixes, “˜ module” and “˜ unit” for a constituent element used for the description below are given or mixed in consideration of only easiness of the writing of the specification, and the suffix itself does not have a discriminated meaning or role.

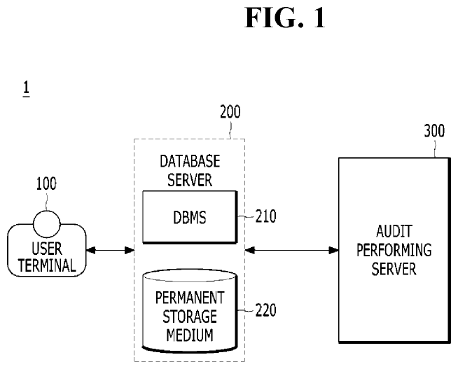

FIG. 1 is a schematic diagram of a database system according to several exemplary embodiments.

Referring to FIG. 1, a database system 1 may include a user terminal 100, a database server 200, and an audit performing server 300. However, the foregoing constituent elements are not essential for implementing the database system 1, so that the database system 1 may include more or less constituent elements than the listed constituent elements.

The user terminal 100, the database server 200, and the audit performing server 300 may be connected with one another by a predetermined network (not illustrated).

The network presented herein may use various wired communication networks, such as a public switched telephone network (PSTN), an x digital subscriber line (xDSL), a rate adaptive DSL (RADSL), a multi rate DSL (MDSL), a very high speed DSL (VDSL), a universal asymmetric DSL (UADSL), and a high bit rate DSL (HDSL).

The network presented herein may use various wireless communication networks, such as code division multi access (CDMA), time division multi access (TDMA), frequency division multi access (FDMA), orthogonal frequency division multi access (OFDMA), single carrier-FDMA (SC-FDMA), and other networks.

The network according to one aspect of the present disclosure may be configured regardless of a communication aspect, such as wire and wireless, and may be configured of various networks, such as a personal area network (PAN), a local area network (LAN), and a wide area network (WAN). Further, the network may be a publicly known world wide web (WWW), and may also use a wireless transmission technology, such as infrared data association (IrDA) or Bluetooth, used in short range communication.

The kind of network is not limited to the examples, and various communication systems may be included in a network.

The user terminal 100 may mean a node(s) in the database system 1 having a mechanism for establishing communication through a network. For example, the user terminal 100 may include a personal computer (PC), a laptop computer, a workstation, a terminal, and/or a predetermined electronic device having network accessibility. Further, the user terminal 100 may also include a predetermined server implemented by at least one of an agent, an application programming interface (API), and plug-in. Further, the user terminal 100 may include an application source and/or a client application.

The user terminal 100 may be a predetermined entity, which includes a processor and a memory, and is capable of processing and storing predetermined data. Further, the user terminal 100 may be related to a user using the database server 200 or communicating with the database server 200. In the example, the user terminal 100 may issue a query to the database server 200. In one example, the user terminal 100 may transfer a compiled and re-recorded query to the database server 200. For example, the user terminal 100 may receive an application source written in a programing language by a developer and the like. Further, for example, the user terminal 100 may generate a client application by compiling an application source. For example, the generated client application may be transferred to the database server 200, and then optimized and executed.

The database server 200 may include a predetermined type of computer system, for example, a microprocessor, a mainframe computer, a digital processor, a portable device, and a device controller, or a computer device. The database server 200 may include a database management system (DBMS) 210 and a permanent storage medium 220. In FIG. 1, one database server and one user terminal are exemplified, but those skilled in the art will clearly appreciate that more database servers (management devices) and more user terminals are also included in the range of the present disclosure.

Although not illustrated in FIG. 1, the database server 200 may include one or more memories including a buffer cache. Further, although not illustrated in FIG. 1, the database server 200 may include one or more processors. Accordingly, the DBMS 210 may be operated by the processor in the memory.

Herein, the memory is a main storage device, such as a random access memory (RAM) including a dynamic RAM (DRAM) and a static RAM (SRAM), to which a processor directly accesses, and may mean a volatile storage device, in which when power is cut, stored information is momentarily erased, but the memory is not limited thereto. The memory may be operated under the control of the processor. The memory may temporarily store a data table including a data value. The data table may include a data value, and in the exemplary embodiment of the present disclosed content, the data value of the data table may be recorded in the permanent storage medium 220 from the memory. In an addition aspect, the memory may include a buffer cache, and data may be stored in a data block of the buffer cache. The data may be recorded in the permanent storage medium 220 by a background process.

The permanent storage medium 220 may mean a non-volatile storage medium, such as a storage device based on a flash memory and/or a battery-backup memory, which is capable of continuously storing predetermined data, as well as a magnetic disk, an optical disk, and a magneto-optical storage device. The permanent storage medium 220 may communicate with the processor and the memory of the database server 200 through various communication means. In an additional exemplary embodiment, the permanent storage medium 220 may be located outside the database server 200 and communicate with the database server 200. Further, in FIG. 1, one permanent storage medium and one DBMS are illustrated, but the form, in which the plurality of DBMS is connected to one permanent storage medium or the form including the plurality of permanent storage media may also be included in the scope of the present disclosure.

The DBMS 210 is a program for allowing performance of operations, such as search, insertion, correction, and/or deletion of required data, in the database server 200, and as described above, the DBMS 210 may be implemented by a processor in the memory of the database server 200.

According to several exemplary embodiments, the database server 200 may transmit query performance details generated through a background system while performing a query to the audit performing server 300 to cause the audit performing server 300 to generate an audit log by using the query performance details. Herein, the query performance details may be the details of the query processed by the database server 200.

The audit performing server 300 may be a server performing a different function from that of the database server 200. Particularly, the database server 200 may process a query received from the user terminal 100, and the audit performing server 300 may perform an audit function for the query processed by the database server 200.

The audit function is a security technology of recording an operation of a user. That is, when a user damages consistency or damages an entire database by operating data within a database intentionally or by mistake, an audit log generated through the audit function is stored in an audit log storage unit, thereby recognizing a user, who operates the data within the database or damages the entire database.

When the database server 200 performs the query and simultaneously performs the audit function, the database server 200 needs to perform the audit function each time whenever performing the query, so that there is a problem in that a load is generated in an operation processing time.

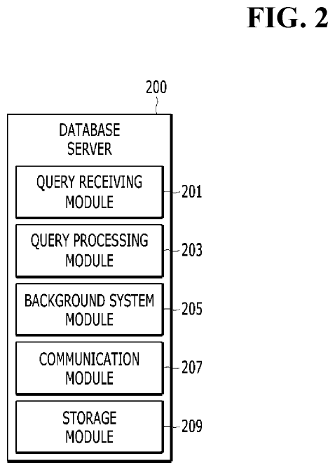

However, like the several exemplary embodiments, in the case where a process of processing a query is separated from a process of performing an audit by dividing the audit performing server 300 and the database server 200 and dependency between the query processing and the audit performance is removed, it is possible to improve database security and decrease a load of the database server. That is, since the database server does not perform the audit, a memory resource of the database server is efficiently used, thereby improving a speed of the database server. Further, since an audit log is not stored in a storage space of the database server, it is possible to efficiently manage the storage space of the database server, thereby storing more data in the database server. This will be described below in detail with reference to FIGS. 2 to 6.

FIG. 2 is a diagram illustrating a block diagram illustrating a database server according to several exemplary embodiments.

Referring to FIG. 2, the database server 200 may include a query receiving module 201, a query processing module 203, a background system module 205, a communication module 207, and a storage module 209. However, the foregoing constituent elements are not essential for implementing the database server 200, so that the database server 200 may include more or less constituent elements than the listed constituent elements. Herein, each of the constituent elements may be configured by a separate chip, module, or device, and may also be included in one device.

The query receiving module 201 may receive a query issued from the user terminal 100. The query receiving module 201 may perform a specific operation for the received query. For example, the query may be parsed, transformed, optimized, and then executed according to an optimized query statement in the DBMS 210.

The query processing module 203 may process the query by performing a circulation on the corresponding query. The query processing module 203 may process the received query by using each of a plurality of performance algorithms.

The background system module 205 may process a separate task from the query processing module 203 as a background.

For example, the background system module 205 may store query performance details in the storage module 209 in linkage with the processing of the query received through the query receiving module 201 by the query processing module 203. That is, the query processing module 203 may process the query, and at the same time, the background system module 205 may store the query performance details in the storage module 209. However, the present disclosure is not limited thereto, and the query processing module 203 may process the query, and then the background system module 205 may also store the query performance details in the storage module 209.

In the meantime, the query performance details may be generated by the background system module 205 whenever the query processing module 203 processes one query.

The query performance details may include at least one of client information, information on query performance time, session information, query type information, object information, and privilege information.

The client information may be information for identifying a user terminal issuing a query. Particularly, when a query is received from a first user terminal, an Internet protocol (IP) address allocated to the first user terminal may be client information. However, the present disclosure is not limited thereto, and various elements of information for identifying a user terminal may be client information.

The information on query performance time may be information on a query processing time.

For example, when a query is processed at a first time point, the first time point may be a query performance time.

For another example, when a query is processed from a first time point to a second time point, time information from the first time point to the second time point may be a query performance time.

The session information may be information on a session of the processed query.

The query type information may be information on the type of processed query. For example, the type of query may include a query related to deletion of data included in a table, a query related to insertion of data into a table, and a query related to generation of a table. The types of query are simply illustrative, and the present disclosure is not limited thereto.

The object information may be information on an object related to the processed query. Herein, the object may include a table, a column, an index, a view, a procedure, a function, and the like.

The privilege information may be information on a privilege set in the processed query. According to several exemplary embodiments, a privilege may also be differently set for each object, differently set for each query, and differently set for each user terminal. However, the present disclosure is not limited thereto, and the privilege may be set in the query by various methods.

The communication module 207 may provide a communication function with another database server, the user terminal 100, and the audit performing server 300.

For example, the communication module 207 may transmit a processing result for the received query to the user terminal 100.

For another example, the communication module 207 may transmit the query performance details stored in the storage module 207 to the audit performing server 300 under the control of the background system module 205. In this case, the query performance details stored in the storage module 207 may also be removed in the storage module 207 for securing a storage space of the storage module 207. However, the present disclosure is not limited thereto.

The communication module 207 may communicate with at least one of another database server, the user terminal 100, and the audit performing server 300 by using the foregoing predetermined network and/or database link.

The communication module 207 may also receive data storage, inquiry and index build, an inquiry request, and the like from the user terminal 100. Further, the communication module 207 may also transfer result information for the data storage, the inquiry and index build, and the inquiry request.

The storage module 209 may store predetermined data stored in relation to task performance of the database server 200. The storage module 209 may be included in the DBMS 210 and/or the permanent storage medium 220.

The storage module 209 may also generate a table and the like of the database server 200. For example, the generation of the tables may also be performed by a separate component from a control module (not illustrated). Further, the storage module 209 may process and manage a request related to the storage (update) of the data. The storage module 209 may determine to store data, an index table, and the like. Further, the storage module 209 may determine a storage position for the data and/or the index table. For example, the storage module 209 may determine a storage position in the data table for the data. For another example, the storage module 209 may determine a storage position in the permanent storage medium 220 for the data.

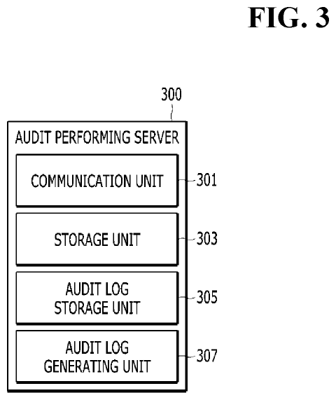

FIG. 3 is a diagram illustrating a block diagram illustrating the audit performing server according to several exemplary embodiments of the present disclosure.

Referring to FIG. 3, the audit performing server 300 may include a communication unit 301, a storage unit 303, an audit log storage unit 305, and an audit log generating unit 307. However, the foregoing constituent elements are not essential for implementing the audit performing server 300, so that the audit performing server 300 may include more or less constituent elements than the listed constituent elements. Herein, each of the constituent elements may be configured by a separate chip, module, or device, and may also be included in one device.

The communication unit 301 may provide a communication function with the database server 200. Particularly, the communication unit 301 may receive the query performance details generated while the database server 200 performs the query from the database server 200. Herein, the query performance details may include at least one of client information, information on query performance time, session information, query type information, object information, and privilege information. The query performance details have been described with reference to FIG. 2, so that the detailed description thereof will be omitted.

The communication unit 301 may communicate with the database server 200 by using the foregoing predetermined network and/or database link.

According to several exemplary embodiments, when a preset audit log is recognized in the audit log storage unit 305, the communication unit 301 may transmit a warning message stored in the storage unit 303 to a preset external device. Herein, the preset external device may be a device of a manager, and the warning message may include information on an audit log.

Particularly, the storage unit 303 may store an algorithm indicating to transmit the warning message stored in the storage unit 303 to the preset external device when the preset audit log is recognized in the audit log storage unit 305. Accordingly, a processor (not illustrated) of the audit performing server 300 may transmit the warning message to the preset external device based on the algorithm stored in the storage unit 303 when the preset audit log is recognized in the audit log storage unit 305.

As described above, in the case where the preset audit log is recognized in the audit log storage unit 305 and the warning message is transmitted to the present external device, when a client damages consistency or damages the entire database by operating data within the database intentionally or by mistake, the warning message may enable a manager to take advance measures.

The processor may be constructed to generally control the operation of the audit performing server 300. Further, the processor may perform various calculations performed by the audit performing server 300 and process data. The processor may be a central processing unit (CPU), a co-processor, an arithmetic processing unit (APU), a graphic processing unit (GPU), a digital signal processor (DSP), an application processor (AP), and a communication processor (CP), and the like.

The storage unit 303 may store data and the like related to the audit function of the audit performing server 300. For example, the storage unit 303 may store audit setting information.

The audit setting information means setting information for using the audit function, and may include information on an audit target set by a manager.

For example, when the manager sets an audit target which means to perform the audit for a query of inserting data to the first table, the audit setting information may include information indicating that the audit target is the query of inserting the data to the first table. However, this is simply one example, and the present disclosure is not limited thereto.

The audit setting information may also include information on the type of audit function to be performed.

For example, when the manager sets to perform a statement audit and a system privilege audit, the audit setting information may include information indicating that the statement audit and the system privilege audit are performed.

The storage unit 303 may be implemented with a volatile memory or a non-volatile memory. Herein, the volatile memory may be implemented with a random access memory (RAM), a static RAM (SRAM), a dynamic RAM (DRAM), a synchronous DRAM (SDRAM), a thyristor RAM (T-RAM), a zero capacitor RAM (Z-RAM), or a twin transistor RAM (TTRAM), which are, however, simply examples, and the volatile memory is not limited thereto. Otherwise, the non-volatile memory may include a NAND flash memory, a vertical NAND (VNAND) flash memory, a NOR flash memory, a resistive random access memory (RRAM), a phase-change memory (PRAM), a magneto resistive RAM (MRAM), a ferroelectric RAM (FRAM), a spin transfer torque RAM (STT-RAM), and the like, which are, however, simply examples, and the non-volatile memory is not limited thereto.

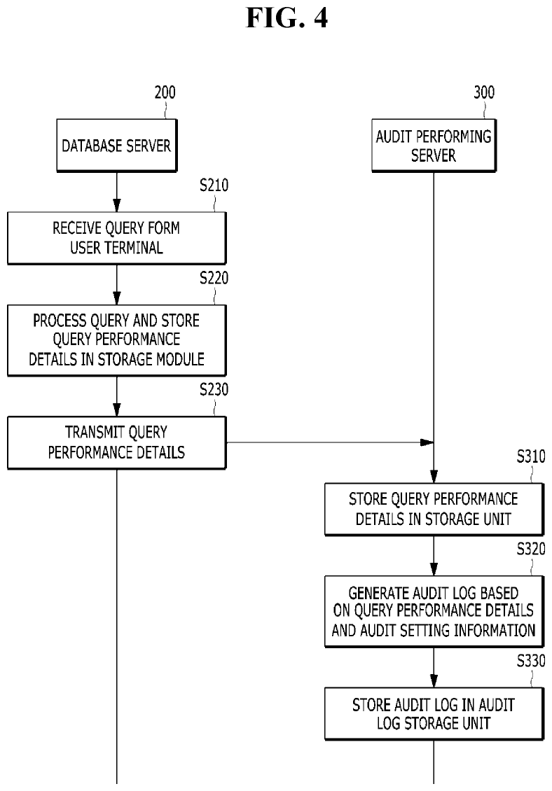

The audit log generating unit 307 may generate an audit log based on the query performance details received from the database server 200 and the audit setting information stored in the storage unit 303. The method of generating the audit log by the audit log generating unit 307 will be described in more detail with reference to FIGS. 4 to 6.

The audit log storage unit 305 may store the audit log generated by the audit log generating unit 307. In FIG. 3, the storage unit 303 and the audit log storage unit 305 are separately described, but the storage unit 303 and the audit log storage unit 305 may use only the different storage spaces in the same memory. However, the present disclosure is not limited thereto, and the storage unit 303 and the audit log storage unit 305 may also be the divided data storage spaces.

In the meantime, the audit log storage unit 305 may be implemented with a volatile memory or a non-volatile memory.

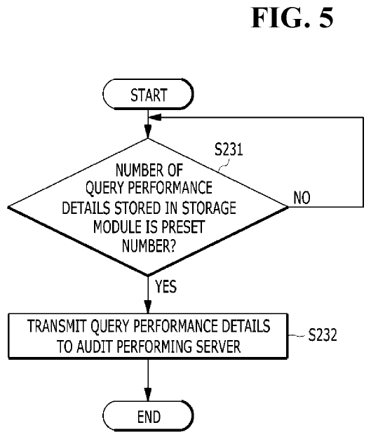

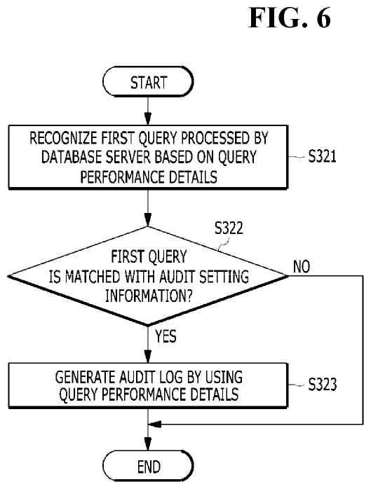

FIG. 4 is a flowchart for describing an example of a method of performing an audit according to several exemplary embodiments of the present disclosure. FIG. 5 is a flowchart for describing an example of a method of transmitting query performance details to the audit performing server according to several exemplary embodiments of the present disclosure. FIG. 6 is a flowchart for describing an example of a method of generating an audit log according to several exemplary embodiments of the present disclosure. In relation to FIGS. 4 to 6, contents overlapping with those described in relation to FIGS. 1 to 3 will not be described again, and differences will be mainly described hereinafter.

Referring to FIG. 4, the query receiving module 201 of the database server 200 may receive a query form the user terminal 100 (S210).

The database server 200 receives the query in operation S210, so that the query processing module 203 may process the received query. In this case, the background system module 205 may store query performance details for the received query in the storage module 209 in linkage with the processing of the received query by the query processing module 203 (S220). Herein, the query performance details may be generated whenever one query is processed and stored in the storage module 209.

The background system module 205 of the database server 200 may control the communication module 207 so as to transmit the query performance details stored in the storage module 209 in operation S220 to the audit performing server 300 (S230).

According to several exemplary embodiments, the background system module 205 may periodically control the communication module 207 and transmit the query performance details to the audit performing server 300.

According to other exemplary embodiments, the background system module 205 of the database server 200 may transmit the query performance details to the audit performing server 300 when a preset condition is satisfied.

Particularly, referring to FIG. 5, the background system module 205 may recognize the number of query performance details stored in the storage module 209 (S231).

When the number of query performance details stored in the storage module 209 does not correspond to a preset number (S231, No), the background system module 205 may continuously recognize whether the number of stored query performance details corresponds to the preset number.

In the meantime, when the number of query performance details stored in the storage module 209 corresponds to the preset number (S231, Yes), the background system module 205 may control the communication module 207 to transmit the query performance details to the audit performing server 300 (S232). Herein, the preset number may be set by the manager setting the audit function.

For example, the manager may set to transmit the query performance details to the audit performing server 300 when two query performance details are stored in the storage module 209. In this case, when the two query performance details generated by processing the two queries by the query processing module 203 are stored in the storage module 209, the background system module 205 may transmit the two query performance details stored in the storage module 209 to the audit performing server 300 by controlling the communication module 207.

That is, when the query performance details are accumulated by a preset number in the storage module 209, the background system module 205 may control the communication module 207 to transmit the query performance details to the audit performing server 300.

When the query performance details stored in the storage module are not frequently transmitted to the audit performing server 300 and the query performance details are transmitted to the audit performing server 300 when the number of query performance details corresponds to the preset number as illustrated in FIG. 5, it is possible to decrease a load of the database server 200.

However, the method of transmitting the query performance details to the audit performing server 300 is not limited to the foregoing exemplary embodiments, and the background system module 205 may transmit the query performance details to the audit performing server 300 by various methods.

According to several exemplary embodiments, the query performance details are transmitted to the audit performing server 300 in operation S230 of FIG. 4, so that the query performance details stored in the storage module 209 may be removed in the storage module 209.

According to several exemplary embodiments, the query performance details are transmitted to the audit performing server 300 in operation S230 of FIG. 4 and a preset time elapses, so that the query performance details stored in the storage module 209 may be removed in the storage module 209.

As described above, when the query performance details are transmitted to the audit performing server 300 and then are removed from the storage module 209, a storage space of the storage module 209 may be secured. However, the present disclosure is not limited thereto, and even when the query performance details are transmitted to the audit performing server 300, the query performance details may not be removed from the storage module 209.

In the meantime, referring back to FIG. 4, the communication unit 301 of the audit performing server 300 may receive the query performance details, which are transmitted from the database server 200 in operation S230 (S310). In this case, the received query performance details may be stored in the storage unit 303.

According to several exemplary embodiments, the query performance details stored in the storage unit 303 may be removed from the storage unit 303 when a preset time elapses. However, the present disclosure is not limited thereto, and the query performance details may also be continuously stored in the storage unit 303.

In the meantime, the audit log generating unit 307 of the audit performing server 300 may generate an audit log based on the query performance details and the audit setting information stored in the storage unit 303 (S320). Herein, the audit setting information may include information on an audit target set by the manager.

Particularly, referring to FIG. 6, the audit log generating unit 307 may recognize a first query processed by the database server 200 based on the query performance details (S321). The query performance details include information on the kind of query and information on an object, so that the audit log generating unit 307 may recognize the first query processed by the database server 200 based on the query performance details.

For example, the database server 200 may process a query of adding data to the first table and transmit query performance details for the corresponding query to the audit performing server 300. In this case, the audit log generating unit 307 of the audit performing server 300 may recognize that the query processed by the database server 200 is the query of adding the data to the first table, based on the received query performance details.

In the meantime, the audit log generating unit 307 of the audit performing server 300 may recognize whether the first query is matched to the audit setting information (S322).

For example, the manager may set to generate an audit log when the query of adding the data to the first table is performed. In this case, the audit log generating unit 307 may recognize whether the first query processed by the database server 200 recognized in operation S321 is the query of adding the data to the first table.

When the audit performing server 300 recognizes that the first query is not the query matched to the audit setting information (S322, No), the audit performing server 300 may terminate the audit function without generating an audit log.

In the meantime, when the audit performing server 300 recognizes that the first query is the query matched to the audit setting information (S322, Yes), the audit log generating unit 307 may generate an audit log by using the query performance details. Herein, the audit log may indicate log data including client information that is information on a user terminal issuing a query, which is desired to be audited, information on a query performance time, information on an action performed by the user terminal, and the like.

According to several exemplary embodiments, when the audit setting information is set so as to generate the audit log by linking at least two of a statement audit, a system privilege audit, and an object audit in operation S320 of FIG. 4, the audit log generating unit 307 may generate the audit log by linking at least two of the statement audit, the system privilege audit, and the object audit based on the audit setting information.

When the database server 200 performs the audit function, the performance of the query and the audit function operation need to be performed at the same time and a parser needs to perform an audit, so that the audit log generating unit 307 may not generate the audit log by linking at least two of the statement audit, the system privilege audit, and the object audit. Accordingly, there are problems in that it is difficult to set an audit range when the audit is performed on connectivity data, and when the range is erroneously set, there is a case where the audit is omitted.

However, when the audit performing server 300 receives the query performance details for the query processed by the database server 200 and then performs the audit like the present disclosure, the performance of the query and the audit function operation do not need to be performed at the same time and the parser does not need to perform the audit, so that the audit performing server 300 may generate the audit log by linking at least two of the statement audit, the system privilege audit, and the object audit. Accordingly, it is easy to set the audit range when the audit is performed on connectivity data, thereby preventing the audit from being omitted.

In the meantime, referring back to FIG. 4, when the audit log is generated in operation S320, the audit log storage unit 305 may store the generated audit log (S330). In this case, the audit log storage unit 305 may store the audit log in a file or a database.

When the system processing the query is separated from the system performing the audit function like the foregoing several exemplary embodiments, it is possible to decrease a load of the database server, thereby solving a problem of degradation of performance of the database server generable according to the performance of the audit function. According to at least one of the foregoing exemplary embodiments, the database server does not perform the audit, so that it is possible to efficiently use a memory resource of the database server, thereby improving a speed of the database server. Further, the audit log is not stored in the storage space of the database server, so that it is possible to more efficiently manage the storage space of the database server, thereby storing more data in the database server.

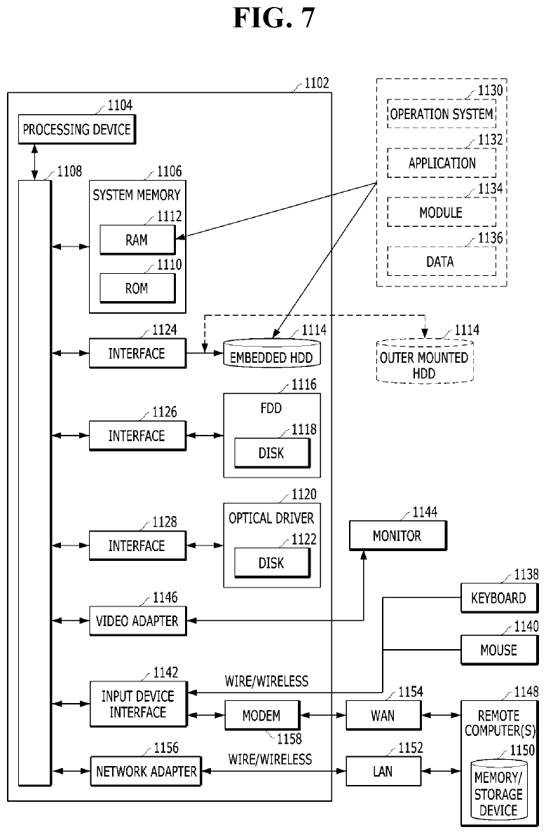

FIG. 7 is a block diagram illustrating a computing device according to an exemplary embodiment of the present disclosure.

FIG. 7 is a simple and general schematic diagram of an illustrative computing environment, in which the exemplary embodiments of the present disclosure may be implemented.

The several exemplary embodiments of the present disclosure may be generally implemented with computer executable commands executable in one or more computers, and those skilled in the art will appreciate well that the several exemplary embodiments of the present disclosure may be combined with other program modules and/or implemented by a combination of hardware and software. According to several exemplary embodiments of the present disclosure, the database server 200 may be a computer, and the audit performing server 300 may also be a computer.

In general, a program module includes a routine, a program, a component, a data structure, and the like performing a specific task or implementing a specific abstract data type. Further, those skilled in the art will appreciate well that the method of the present disclosure may be carried out by a single-processor or a multi-processor computer system, a mini computer, a main computer, a personal computer, a hand-held computing device, a microprocessor-based or programmable home appliance, and the like (each of which may be connected with one or more relevant devices and operated), and other computer system configurations.

The exemplary embodiments of the present disclosure may be carried out in a distribution computing environment, in which certain tasks are performed by remote processing devices connected through a communication network. In the distribution computing environment, a program module may be positioned in both a local memory storage device and a remote memory storage device.

The computer generally includes various computer readable media. A computer accessible medium may be a computer readable medium regardless of the kind of medium, and the computer readable medium includes volatile and non-volatile media, transitory and non-non-transitory media, portable and non-portable media. As a non-limited example, the computer readable medium may include a computer readable storage medium and a computer readable transport medium. The computer readable storage medium includes volatile and non-volatile media, transitory and non-non-transitory media, and portable and non-portable media constructed by a predetermined method or technology, which stores information, such as a computer readable command, a data structure, a program module, or other data. The computer storage medium includes a read only memory (RAM), a read only memory (ROM), electrically erasable and programmable ROM (EEPROM), a flash memory, or other memory technologies, a compact disc (CD)-ROM, a digital video disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally includes all of the information transport media, such as a carrier wave or other transport mechanisms, which implement a computer readable command, a data structure, a program module, or other data in a modulated data signal. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not illustrated) to the processing device 1104. The processing device 1104 may be a predetermined processor among various common processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routine helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of predetermined data in an appropriate digital form. In the description of the computer readable storage media, the HDD, the portable magnetic disk, and the portable optical media, such as a CD, or a DVD, are mentioned, but those skilled in the art will appreciate well that other types of computer readable storage media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display device are also connected to the system bus 1108 through an interface, such as a video adapter 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a workstation, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, Internet.

When the computer 1102 is used in the LAN networking environment, the computer 1102 is connected to the local network 1152 through a wired and/or wireless communication network interface or an adapter 1156. The adapter 1156 may make wired or wireless communication to the LAN 1152 easy, and the LAN 1152 may also include a wireless access point installed therein for the communication with the wireless adapter 1156. When the computer 1102 is used in the WAN networking environment, the computer 1102 may include a modem 1158, is connected to a communication computing device on a WAN 1154, or includes other means setting communication through the WAN 1154 via the Internet and the like. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, electric fields or particles, optical fields or particles, or a predetermined combination thereof.

Those skilled in the art will appreciate that the various illustrative logical blocks, modules, processors, means, circuits, and algorithm operations described in relation to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable device. Herein, the media may include storage media and transport media. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information. Further, the transport media include a wireless channel and various other media, which are capable of transporting a command(s) and/or data, but are not limited thereto.

It shall be understood that a specific order or a hierarchical structure of the operations included in the presented processes is an example of illustrative accesses. It shall be understood that a specific order or a hierarchical structure of the operations included in the processes may be re-arranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

1. A non-transitory computer readable storage medium including instructions that when executed perform a process for performing an audit the process comprising:
receiving query performance details generated while performing a query from a database server;
storing the query performance details in a storage unit;
generating an audit log based on the query performance details and audit setting information stored in the storage unit; and
storing the audit log in an audit log storage unit.

2. The non-transitory computer readable storage medium of claim 1, wherein the generating of the audit log includes:
recognizing a first query processed by the database server based on the query performance details; and
generating the audit log by using the query performance details when the first query is matched to the audit setting information.

3. The non-transitory computer readable storage medium of claim 1, wherein the generating of the audit log is generated by linking at least two of a statement audit, a system privilege audit, and an object audit based on the audit setting information.

4. The non-transitory computer readable storage medium of claim 1, wherein the query performance details include at least one of client information, information on a query performance time, session information, query type information, object information, and privilege information.

5. The non-transitory computer readable storage medium of claim 1, wherein the audit setting information includes information on an audit target set by a manager.

6. The non-transitory computer readable storage medium of claim 1, further comprising:
transmitting a warning message to a preset external device when a preset audit log is recognized.

7. The non-transitory computer readable storage medium of claim 1, wherein the storing of the audit log in the audit log storage unit includes storing the audit log in a file or a database.

8. A non-transitory computer readable storage medium including instructions that when executed perform a process for performing an audit, the process comprising:
receiving a query from a user terminal;
processing the query through a query processing module;
storing query performance details in a storage module through a background system module in linkage with the processing of the query; and
controlling a communication module through the background system module so as to transmit the query performance details stored in the storage module to an audit performing server in order to cause the audit performing server to generate an audit log by using the query performance details.

9. The non-transitory computer readable storage medium of claim 8, wherein the query performance details include at least one of client information, information on a query performance time, session information, query type information, object information, and privilege information.

10. The non-transitory computer readable storage medium of claim 8, wherein the transmission of the query performance details to the audit performing server occurs when a preset number of the query performance details is accumulated in the storage module.

11. A server for performing an audit, the server comprising:
a processor configured to receive query performance details generated while performing a query from a database server; and
memory configured to store query performance details received from the database server,
wherein the processor is further configured to generate an audit log based on the query performance details and audit setting information stored in the storage unit, and
wherein the memory is further configured to store the audit log.

12. A database server comprising:
a transceiver configured to receive a query from a user terminal;
a processor configured to process the query received from the user terminal; and
memory configured to store query performance details in linkage with the query processed by the processor,
wherein the processor is further configured to control the transceiver to transmit the query performance details stored in the memory to an audit performing server in order to cause the audit performing server to generate an audit log by using the query performance details.
